(19) United States
(12) Patent Application Publication
(10) Pub. No.: US 2013/0107888 A1
(43) Pub. Date: May 2, 2013

(54) IPv6 Transition Tool Handling

(71) Applicant: Lei GUO, Shanghai (CN)

(72) Inventor: Lei GUO, Shanghai (CN)

(73) Assignee: Telefonaktiebolaget L M Ericsson (publ), Stockholm (SE)

(21) Appl. No.: 13/287,507

(22) Filed: Nov. 2, 2011

Related U.S. Application Data
(63) Continuation of application No. PCT/CN2011/001803, filed on Oct. 28, 2011.

(51) Int. Cl. H04L 12/56

(52) U.S. Cl. 370/401

(57) ABSTRACT

The present invention relates to a method for signalling in an infrastructure network comprising a Source Serving Node (S-SN), a Target Serving Node (T-SN), and a first Gateway. At least one Packet Data Network (PDN) bearer is established for a User Equipment when at least one PDN bearer is handed over from the S-SN to the T-TN. The network performs the steps of: sending, by the T-SN to the first GW, a modify bearer request indicating that the T-SN does not support dual Internet Protocol (IP) addressing for said PDN bearer being handed over; initiating, by the first GW on the basis of the received modify bearer request, a modify bearer procedure where a new PDN bearer type for single IF addressing is defined; and sending, by the first GW to the T-SN, a modify bearer response comprising information about the new PDN bearer type.

### CROSS-REFERENCE TO RELATED APPLICATIONS

This application is a continuation of International Application No. PCT/2011/xxxx, filed on Oct. 28, 2011, entitled IPv6 Transition Tool Handling and naming Lei GUO as inventor.

### TECHNICAL FIELD

The present invention relates to a method for signalling in an infrastructure network comprising Source Serving Node, S-SN, a Target Serving Node, T-SN , and a first Gateway, GW, wherein at least one Packet Data Network, PDN, bearer is established for a UE. The present invention further relates to a T-SN and a first GW adapted for the same purpose.

### BACKGROUND ART

Different transition mechanisms are available for IPv6. These mechanisms are intended to ensure interoperability between IPv4 and IPv6 and can be categorized in three broad classes: dual-stack, tunnels, and translation mechanisms.

The term “dual-stack” refers to TCP/IP capable devices providing support for both IPv4 and IPv6. The term “tunneling” refers to a means to encapsulate one version of IP in another so the packets can be sent over a backbone that does not support the encapsulated IP version. The term “translators” refers to devices capable of translating traffic from IPv4 to IPv6 or vice and versa.

IPv4v6 PDP/PDN (Packet Data Protocol/Packet Data Network) type has been introduced in 3GPP as a vital IPv6 transition tool in mobile network. In 3GPP, a Dual Address Bearer Flag is further defined. These are for instance used in GTP tunnels between two nodes communicating over a GTP (GPRS Tunnelling Protocol) based interface. For GTPv2-C, the Dual Address Bearer Flag is defined in 3GPP TS 29.274, as a bit within Indication IE (Information Element), and shall be used on GTPv2-C based interface, for instance S2b, S11/S4 and S5/S8. The flag shall be set to 1 when the PDN Type, determined based on UE request and subscription record, is set to IPv4v6 and all SGSNs (Serving Gateway Support Node), which the UE may be handed over to, support dual addressing. This shall be determined based on node pre-configuration by the operator.

For GTPv1-C, the Dual Address Bearer Flag is defined in 3GPP TS 29.060 as a bit within Common Flags IE (Information Element), and shall be used on GTPv1-C based interface, for instance Gn/Gp. The flag should be set to 1 when the PDP type, determined based on MS (Mobile Station) request and subscription record, is set to IPv4v6 and all SGSNs which the UE may be handed over to support dual addressing. This shall be determined based on node pre-configuration by the operator.

This is to say that IPv4v6 bearer shall not be established for the MS/UE (Mobile Station/User Equipment), if one (or more than one) SGSN (Serving GPRS Support Node) that the MS/UE may be handed over to doesn't support dual addressing. This limits the use of IPv4v6 bearer, even if some or most of the SGSNs in the network have already been capable of dual addressing.

As an exceptional flow, there is possibility that the Dual Address Bearer Flag bit is set to 1, but not in accordance with 3GPP. The MS/UE with IPv4v6 bearer is going to be handed over to a SGSN which doesn't support dual addressing. It is uncertain now what will happen. The third problematic scenario is when the MS/UE is handed over from the dual addressing capable 3GPP access to the dual addressing incapable non-3GPP access.

### SUMMARY

The object of the present invention is therefore to introduce a fallback procedure which can handle a scenario where at least one SGSN or non-3GPP Serving Node in an infrastructure network does not support dual addressing.

The object of the present invention is solved by means of a method for signalling in an infrastructure network comprising a Source Serving Node, S-SN, a Target SN, T-SN and a first Gateway. At least one Packet Data Network, PDN, bearer is established for a User Equipment, UE, when at least one PDN bearer is handed over from the S-SN to the T-TN. The network performs the steps of:

the T-SN sends a modify bearer request to the first GW, said bearer request indicating that the T-SN does not support dual Internet Protocol (IP) addressing for said PDN bearer being handed over,

the first GW on the basis of the received modify bearer request initiates a modify bearer procedure where a new Packet Data Network, PDN, bearer type for single IP addressing is defined,

the first GW further sends a modify bearer response to the T-SN, said bearer response comprising information about the new PDN bearer type.

The object of the present invention is also solved by means of a Target Serving Node, T-SN, arranged for signalling in an infrastructure network comprising the T-SN and a first GW. At least one Packet Data Network, PDN, bearer is established for a User Equipment, UE. At least one PDN bearer is handed over from a Source Serving Node, S-SN, in the network to the Target SN, T-SN. The T-SN is arranged to send a modify bearer request to the first GW, said bearer request indicating that the T-SN does not support dual Internet Protocol (IP) addressing for said PDN bearer being handed over.

The object of the present invention is also solved by means of a first Gateway, GW, arranged for signalling in an infrastructure network comprising the first GW, wherein at least one Packet Data Network, PDN, bearer is established for a User, Equipment , UE. When the at least one PDN bearer is handed over to the Target SN, T-SN, according to any of the claims 9-12, the first GW on the basis of the received modify bearer request is arranged to initiate a modify bearer procedure, where a new Packet Data Network, PDN, bearer type for single IP addressing is defined. The first GW further is arranged to send a modify bearer response to the T-SN, said bearer response comprising information about the new PDN bearer type.

The present invention provides a method which enables usage of IPv4v6 bearer even if not all of the SGSNs or non-3GPP SNs (Serving Node) in the infrastructure network that the UE is handed over to supports dual addressing. The method improves the session continuity by failing the dual addressing back to single addressing hen the SGSN or non-3GPP SNs that the UE is handed over to do not support dual addressing.

### BRIEF DESCRIPTION OF THE DRAWINGS

The invention will be described in greater detail in the following, with reference to the embodiments that are shown in the attached drawings, in which:

FIG. 1 illustrates the involved entities in the present invention.

FIG. 2 illustrates a first embodiment of a control plane setup for a Routing Area Update procedure according to the present invention.

FIG. 3 illustrates different scenarios for an UE movement from a dual addressing capable S-SN to a dual addressing incapable T-SN.

FIG. 4 illustrates a second embodiment of a control plane setup for a Routing Area Update procedure according to the present invention.

FIG. 5 illustrates the method according to the present invention.

### DETAILED DESCRIPTION

The embodiments of the invention with further developments described in the following are to be regarded only as examples and are in no way to limit the scope of the protection provided by the patent claims.

The present invention relates to a method for signalling in an infrastructure network comprising a Source Serving Node, S-SN, a Target SN, T-SN and a first Gateway, wherein a dual addressing UE moved from the S-SN to the T-SN. The S-SN is capable for handling dual addressing while the T-SN is incapable of handling dual addressing. The present invention also relates to a Target Serving Node and a first Gateway arranged for the same purpose. Even though the detailed description describes the method performed by this entities/network, the person skilled in the art realizes that this entities/network adapted to perform these method steps is also disclosed in the description.

IPv4v6 bearer shall not be established for the MS/UE (Mobile Station/User Equipment), if one (or more than one) Serving Node that the MS/UE may be handed over to doesn't support dual addressing. This limits the use of IPv4v6 bearer, even if some of the Serving Nodes in the network have already been capable of dual addressing. The object of the present invention is therefore to introduce a bearer fallback procedure which can handle a scenario where at least one Serving Node in an infrastructure network does not support dual addressing.

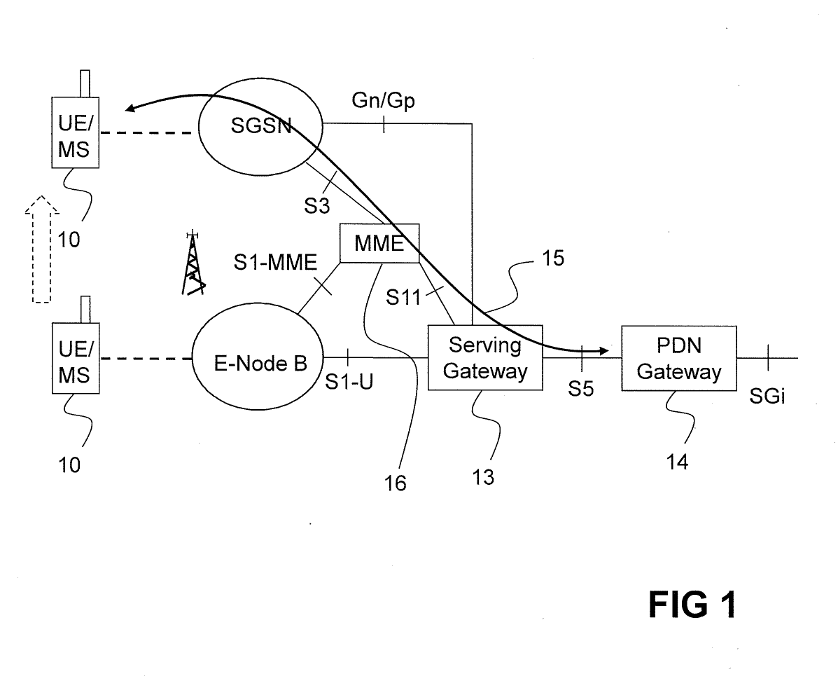

FIG. 1 shows involved entities in the present invention. The infrastructure network comprises a Serving Gateway 13 (S-GW), and a PDN Gateway 14, (PDN-GW). At least one Packet Data Network, PDN, bearer 15 is established for a User Equipment 10, UE, between the UE and the PDN-GW.

The term Serving Node will be used in the following. A Source Serving Node, S-SN, is capable of handling dual addressing while a Target Serving Node, T-SN, is incapable of handling dual addressing. The S-SN and the T-TN are part of the infrastructure network.

A person skilled in the art realizes that a Serving Node is for instance in 3GPP a SGSN (Serving GPRS Support Node) or an MME (Mobility Management Entity). 3GPP compliant MME, S4-SGSN and Gn/GP SGSN compliant with 3GPP Release 9 or later are usually capable of handling dual addressing. Gn/Gp SGSN compliant with 3GPP Release 8 or earlier, as well as non-3GPP SN's, are usually incapable to handle dual addressing.

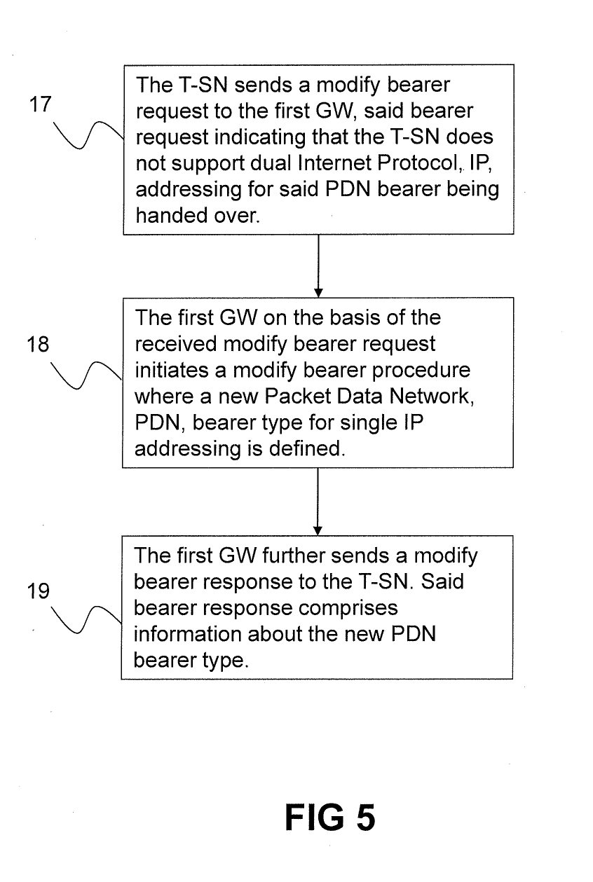

In the present invention, see FIG. 5, when at least one PDN bearer 15 is handed over from the S-SN, to the T-SN, the network performs the steps of: (a) the T-SN sends 17 a modify bearer request to a first GW 13, 14. Said bearer request indicates that the T-SN does not support dual Internet Protocol (IP) addressing for said PDN bearer 15 being handed over; (b) the first GW 13, 14 on the basis of the received modify bearer request initiates 18 a modify bearer procedure where a new Packet Data Network, PDN, bearer type for single IP addressing is defined; (c) the first GW 13, 14 further sends 19 a modify bearer response to the T-SN. Said bearer response comprises information about the new PDN bearer type.

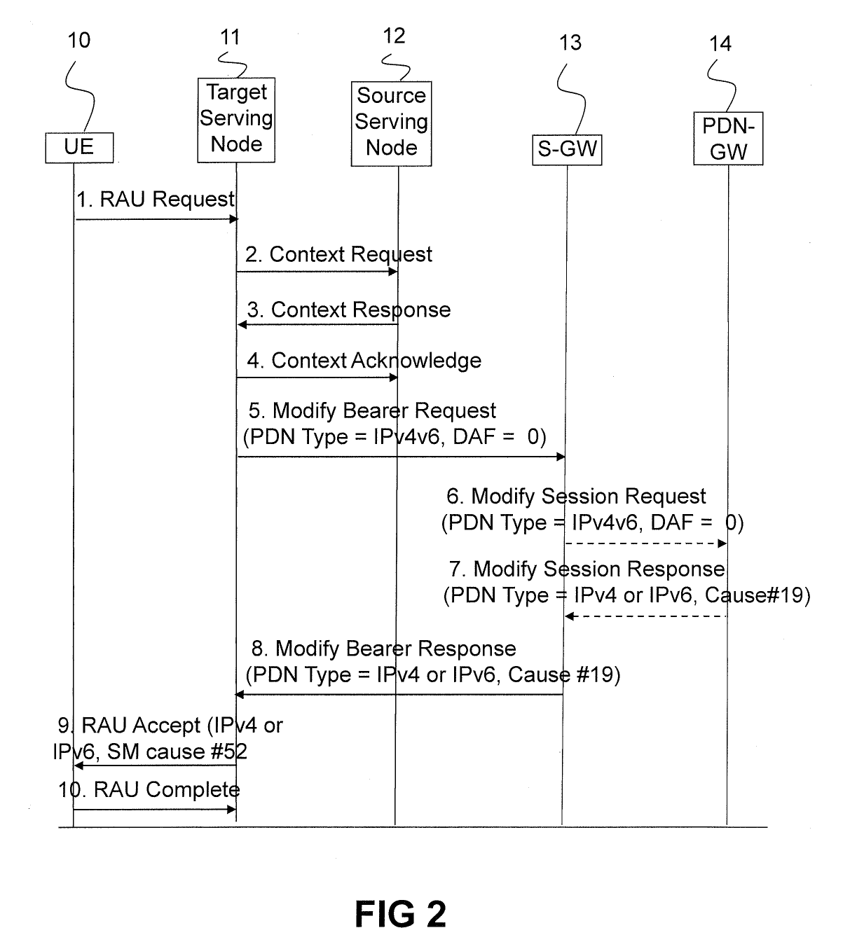

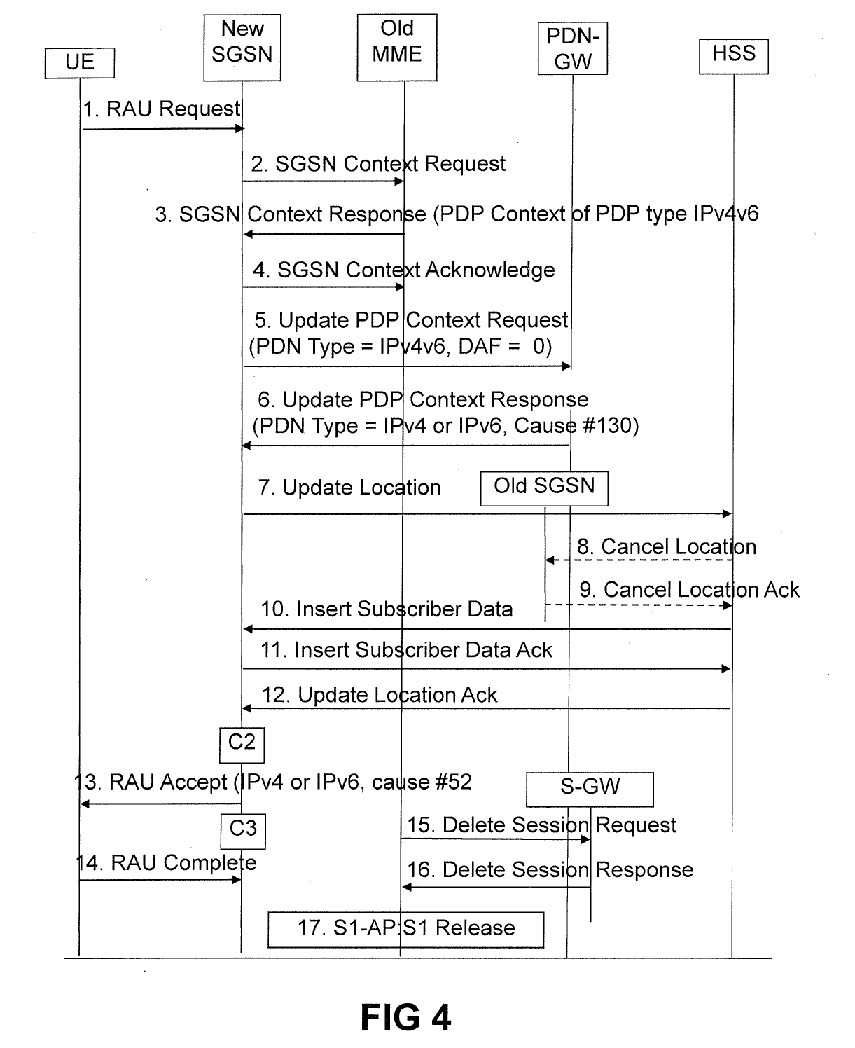

The first GW is for instance the S-GW 13 or the PDN-GW 14 as will be illustrated with reference to FIGS. 2 and 4. It may also be a GGSN (Gateway GPRS Support Node). The main concept of the present invention is therefore provide a procedure which covers all scenarios when the UE 10 moves from dual addressing capable S-SN to dual addressing incapable T-SN.

The procedure according to the present invention enables usage of IPv4v6 bearer even if not all of the SGSNs in the infrastructure network that the UE is handed over to supports dual addressing. The method improves the session continuity. When the SGSN or non-3GPP that the UE is handed over to do not support dual addressing, the bearer falls back to single address signalling.

An embodiment of the present invention will be described with reference to FIG. 2. In this embodiment, a Routing Area Update is requested. The PDN bearer 15 is to be moved from the S-SN 12 (a S4 SGSN or MME) capable of handling IPv4v6 bearers to the T-SN 11 (a SGSN) incapable of handling IPv4v6 bearers. In the procedure there is no change of S-GW 13. The following steps are performed:
1. UE 10 with IPv4v6 bearer(s) moves (see dotted arrow in FIG. 2) and is going to be handed over to the T-SN 11, which doesn't support dual addressing. The T-SN receives a Routing Area Update Request.
2. The T-SN 11 sends a Context Request to the S-SN 12 (an MME or S4 SGSN).
3. The S-SN 12 responds with a Context Response (IPv4v6 Bearer Contexts) to the T-SN 11.
4. The T-SN 11 sends a Context Acknowledge to the S-SN 12.
5. The T-SN 11 sends a Modify Bearer Request (IPv4v6,DAF=0) to the Serving GW 13. The first GW is consequently here represented by the S-GW. The flag DAF=0 indicates that the T-SN doesn't support dual addressing. The modify bearer request consequently comprises a Dual Address Bearer Flag (DAF) that is set to null to indicate that the T-SN does not support dual Internet Protocol (IP) addressing for said bearer being handed over.
6. The S-GW 13 sends a Modify Session Request (IPv4v6, DAF=0) to a second GW, being the PDN-GW 14. The Dual Address Bearer Flag (DAF) is set to null to indicate that the T-SN does not support dual Internet Protocol (IP) addressing for said PDN bearer. Said session request consequently indicates that T-SN 11 does not support dual IP addressing for said PDN bearer 15 being handed over.
7. The PDN-GW 14 (second GW) responds with a Modify Session

Response (PDN Type=IPv6, Cause#19). Cause #19 indicates: “New PDN type due to single address bearer only”. The PDN-GW consequently indicates the new PDN bearer type.
8. S-GW 13 (first GW) sends a Modify Bearer Response (PDN Type=IPv6 or IPv4, Cause#19) to the T-SN 11. The new PDN type, IPv6 or IPv4, can be configurable in the PDN-GW 14.
9. The T-SN 11 sends a Routing Area Update Accept to the UE 10 (PDN Type=IPv6 or IPv4, SM cause #52. Cause #52 indicates: “single address bearers only allowed”. The T-SN when receiving the modify bearer response it consequently sends a service response to the UE with information about the new PDN bearer type.
10. The UE 10 responds with a Routing Area Update Complete. The UE may request a new PDN connection for another IP version subsequently.
The UE consequently is able to request for a new PDN connection on the basis of the new PDN bearer type.

A person skilled in the art realizes that step 5 implies that the T-SN 11 determines that dual IP addressing is present on said PDN bearer 15 being handed over on the basis of bearer contexts provided by the S-SN 12 during a context exchange procedure.

A second embodiment is shown in FIG. 4. In this embodiment, a Routing Area Update is requested. UE changes from UTRAN to GERAN. The PDN bearer 15 is to be moved from an old SGSN (the S-SN), capable of handling IPv4v6 bearers, to a new SGSN (the T-SN), incapable of handling IPv4v6 bearers. Signalling with old MME is also performed to get information of bearer type. The figure itself illustrates the different steps and they will therefore not be described in detail here.

In this embodiment, the first GW is represented by the PDN-GW 14 which receives said Modify Bearer Request (IPv4v6, DAF=0), here named “Update PDP Context Request”, from the T-SN. No Modify Session Request/Response is present since no second GW is involved. The PDN-GW 14 (first GW) responds to the Modify Bearer Request with a Modify Session Response (PDN Type=IPv6, Cause#130), here named “Update PDP Context Response”. Cause #130 indicates: “New PDN type due to single address bearer only”. The PDN-GW consequently indicates the new PDN bearer type.

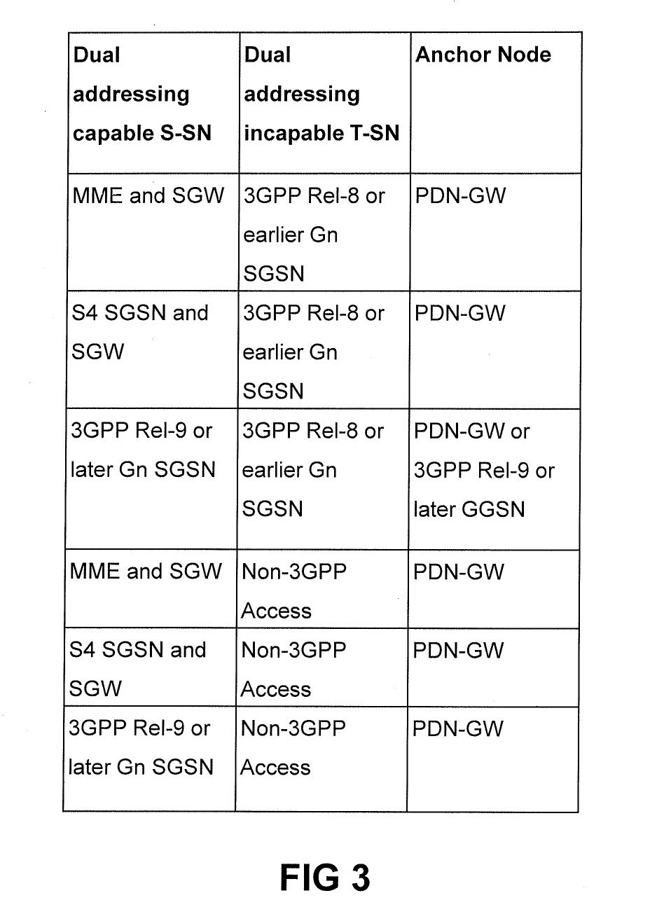

It will be appreciated by a person skilled in the art that the invention is not to be regarded as being limited to the embodiments described above, a number of additional variants and modifications being possible within the scope of the subsequent patent claims In the procedure according to FIGS. 2 and 4, there is a RAU (Routing Area Update) procedure where the PDN bearer 15 is to be moved from the S-SN 12 (for example a S4 SGSN or MME) to the T-SN 11 (for example a Gn-SGSN) incapable of handling IPv4v6 bearers. FIG. 3 illustrates further scenarios for an UE movement from a dual addressing capable S-SN to a dual addressing incapable T-SN. The anchor node is either PDN-GW or GGSN (Gateway GPRS Support Node). The person skilled in the art would realize that the following applicable scenarios are also embraced within the present invention:

UE move from IPv4v6 capable S-SN (MME or S4 SGSN and S-GW) to IPv4v6 incapable non-3GPP access.

UE move from IPv4v6 capable S-SN (Gn-SGSN) to IPv4v6 incapable non-3GPP access.

In all applications there is a need for the procedure according to FIG. 5 to be performed. That is that the UE 10, the T-SN 11, the S-SN 12, and the first GW 13,14 exchanges information to ensure an IPv4v6 bearer fallback to single address when a node in the infrastructure network does not support dual Internet Protocol (IP) addressing for a PDN bearer 15 being handed over.

1. A method for signalling in an infrastructure network comprising a Source Serving Node (S-SN), a Target Serving Node (T-SN), and a first Gateway, wherein at least one Packet Data Network (PDN) bearer is established for a User Equipment (UE), comprising:
sending, by the T-SN, a modify bearer request to the first GW, said bearer request indicating that the T-SN does not support dual Internet Protocol (IP) addressing for a PDN bearer being handed over from the S-SN to the T-SN;
on the basis of the received modify bearer request, initiating, by the first GW, a modify bearer procedure where a new Packet Data Network (PDN) bearer type for single IP addressing is defined; and
sending, by the first GW, a modify bearer response to the T-SN, said bearer response comprising information about the new PDN bearer type.

2. The method of claim 1, wherein the step of initiating the modify bearer procedure comprise the steps of:
sending, by the first GW, a modify session request to a second GW, said session request indicating that T-SN does not support dual IP addressing for said PDN bearer being handed over; and
receiving, at the first GW, a modify session response sent by the second GW, said session response indicating the new PDN bearer type.

3. The method of claim 2, wherein the modify session request comprising a Dual Address Bearer Flag being set to null to indicate that the T-SN does not support dual Internet Protocol (IP) addressing for said PDN bearer being handed over.

4. The method of claim 1, wherein the T-SN determines that dual IP addressing is present on said PDN bearer being handed over on the basis of bearer contexts provided by the S-SN during a context exchange procedure.

5. The method of claim 1, wherein the modify bearer request comprises a Dual Address Bearer Flag being set to null to indicate that the T-SN does not support dual Internet Protocol (IP) addressing for said bearer being handed over.

6. The method of claim 1, wherein the T-SN when receiving said modify bearer response sends a service response to the UE with information about the new PDN bearer type.

7. The method of claim 1, wherein the new PDN bearer type is IPv4 or IPv6 that can be configured in the PDN-GW.

8. The method of claim 1, wherein the UE requests for a new PDN connection on the basis of the new PDN bearer type.

9. A Target Serving Node (T-SN) arranged for signalling in an infrastructure network comprising the T-SN and a first GW, wherein at least one Packet Data Network (PDN) bearer is established for a User Equipment (UE), the T-SN being operable to send to the first GW a modify bearer request indicating that the T-SN does not support dual Internet Protocol (IP) addressing for a PDN bearer being handed over from a Source Serving Node (S-SN) to the T-SN.

10. The T-SN of claim 9, wherein the T-SN is arranged to determine that dual IP addressing is present on said PDN bearer being handed over on the basis of bearer contexts provided by the S-SN during a context exchange procedure.

11. The T-SN of claim 9, wherein the T-SN is arranged to set a Dual Address Bearer Flag in the modify bearer request to null to indicate that the T-SN does not support dual Internet Protocol (IP) addressing for said PDN bearer being handed over.

12. The T-SN of claim 9, wherein the T-SN when receiving a modify bearer response from the first GW is arranged to send a service response to the UE with information about the new PDN bearer type.

13. A first gateway (GW) arranged for signalling in an infrastructure network comprising the first GW, wherein at least one Packet Data Network (PDN) bearer is established for a User Equipment (UE), wherein, the first GW, on the basis of a received modify bearer request indicating that a Target Serving Node (T-SN) does not support dual Internet Protocol (IP) addressing for a PDN bearer being handed over, is arranged to initiate a modify bearer procedure, where a new Packet Data Network (PDN) bearer type for single IP addressing is defined, the first GW further is arranged to send a modify bearer response to the T-SN, said bearer response comprising information about the new PDN bearer type.

14. The first GW of claim 13, wherein the first GW during the modify bearer procedure is arranged to send a modify session request to a second GW, said session request indicating that T-SN does not support dual IF addressing for said PDN bearer being handed over, the first GW further being arranged to receive a modify session response from the second GW, said session response indicating the new PDN bearer type.

15. The first GW of claim 14, wherein the first GW is arranged to set a Dual Address Bearer Flag in the modify session request to null to indicate that the T-SN does not support dual Internet Protocol (IP) addressing for said bearer being handed over.
